(19) United States
(12) Patent Application Publication
(10) Pub. No.: US 2014/0088836 A1
(43) Pub. Date: Mar. 27, 2014

(54) Method and Control System for Adjusting at Least One Side Mirror of a Motor Vehicle

(71) Applicant: Jochen Staack, Stuttgart (DE)

(72) Inventor: Jochen Staack, Stuttgart (DE)

(73) Assignee: ROBERT BOSCH GmbH, Stuttgart (DE)

(21) Appl. No.: 14/110,185

(22) PCT Filed: Mar. 1, 2012
(86) PCT No.: PCT/EP2012/053505

§ 371 Date: Dec. 10, 2013

(30) Foreign Application Priority Data
Apr. 8, 2011 (DE) 10 2011 007 017.6

(51) Int. Cl. G05D 3/00

(52) U.S. Cl. CPC G05D 3/00
USPC 701/49

(57) ABSTRACT

A method by which a setting, which corresponds to a type of parking space, of at least one side mirror of a motor vehicle is ensured during a parking operation, the method including at least the following: a. a control unit of the motor vehicle detects the type of parking space into which the motor vehicle is to be parked, b. the control unit initiates an adjustment of the side mirror to a setting which is adapted to the type of parking space detected in step a. if an instantaneous setting of the side mirror does not correspond to the setting which is adapted to the type of parking space detected in step a.

### FIELD OF THE INVENTION

The present invention relates to a method with the aid of which a setting, which corresponds to a type of a parking space, of at least one side mirror of a motor vehicle is achieved during a parking operation. Furthermore, the present invention relates to a control system for adjusting at least one side mirror of a motor vehicle, the control system having a control unit for automatically adjusting the side mirror.

### BACKGROUND INFORMATION

A motor vehicle is usually parked either into a parallel parking space or into a perpendicular parking space, in particular in reverse. When parking into a parallel parking space, the driving direction of the motor vehicle to be parked prior to the parking operation is parallel to the orientation of the motor vehicle in the parked state, while when parking into a perpendicular parking space, the driving direction of the motor vehicle to be parked prior to the parking operation is essentially perpendicular to the orientation of the motor vehicle in the parked state. These definitions of the parallel parking space and the perpendicular parking space should be maintained in the following. If a motor vehicle is parked into a parallel parking space, it is advantageous that a right-hand side mirror of the motor vehicle is set in such a way that a driver of the motor vehicle probably sees a curb in the right-hand side mirror.

According to the related art, the right-hand side mirror is therefore always brought automatically, i.e., without manual operation by the driver, into a position in which the driver probably sees the curb in the right-hand side mirror when the driver shifts into the reverse gear. In this case, the right-hand side mirror is usually tilted further toward ground.

It is believed that the disadvantage of the automatic setting of the right-hand side mirror is that when the driver shifts into the reverse gear, he sees in the right-hand side mirror an area which is close to the ground even if he does not want to park into a parallel parking space, but into a perpendicular parking space. This setting of the right-hand side mirror is not helpful in the case of a perpendicular parking space. The driver therefore must manually reset the mirror into a position which is helpful when parking into a perpendicular parking space.

### SUMMARY OF THE INVENTION

It is therefore the object of the present invention to provide a method and a control system for adjusting at least one side mirror of a motor vehicle in which a driver is able to park in reverse with the side mirrors automatically advantageously set, regardless of the type of parking space.

To achieve the object, a method is proposed having the features described herein. The further embodiments herein provide advantageous refinements of the method. The object is furthermore achieved by a control system having the features described herein. Advantageous refinements of the method are indicated in the dependent device claims. Features and details which are described in conjunction with the method according to the present invention naturally also apply in conjunction with the control system according to the present invention and vice versa. The features mentioned in the claims and in the description may each be essential for the present invention either individually or in combination.

It is provided according to the present invention that the method has at least the following steps:
a. a control unit of the motor vehicle detects the type of parking space into which the motor vehicle is to be parked,
b. the control unit initiates an adjustment of the side mirror to a setting which is adapted to the type of parking space detected in step a. if an instantaneous setting of the side mirror does not correspond to the setting which is adapted to the type of parking space detected in step a.

Here, the type of parking space may in particular be a parallel parking space or a perpendicular parking space. It is, however, conceivable that other types of parking spaces are integrated into the method according to the present invention. The steps of the method according to the present invention are carried out in the following sequence: a., b. Step b. is carried out automatically, i.e., without an action being required by the driver of the motor vehicle. Step a. may be carried out automatically. Prior to, in-between, and after steps a. and b., the method may optionally have other steps. The fact that an instantaneous setting of the side mirror does not correspond to the ascertained setting may be assumed by the control unit or ascertained based on the information available to the control unit. During the parking operation, the motor vehicle is in particular parked in reverse.

The core of the present invention is that a control unit of the motor vehicle receives information in step a. into which type of parking space the motor vehicle is supposed to park. Only then is the side mirror adjusted, if necessary, so that the particular setting of the side mirror corresponds to the setting which matches the particular type of parking space. If, prior to the method or/and during step a., the side mirror is in a setting which matches the type of parking space into which the motor vehicle is to be parked, the side mirror is not adjusted, but remains in this setting.

The method according to the present invention provides a method using which a setting of at least one side mirror, which is advantageous for every type of parking space into which the motor vehicle is to be parked, is achieved, an adjustment of the side mirror, which might be necessary, always taking place automatically. A manual adjustment of the side mirror is dispensed with for every parking operation.

The side mirror may be a right-hand side mirror. It is also conceivable that the method according to the present invention is carried out only for the left-hand side mirror or for both side mirrors.

The method according to the present invention may in particular be a part of an autonomous or semi-autonomous parking operation. Here, a semi-autonomous parking operation is understood to mean that a parking control device takes over the lateral guidance, i.e., the steering, of the motor vehicle during the parking operation. In the case of an autonomous parking operation, the parking control device also takes over the longitudinal guidance, i.e., the speed control. The method according to the present invention may be integrated into the autonomous or semi-autonomous parking operation. At least one parking space is measured at the beginning of the parking operation in the case of both a semi-autonomous and an autonomous parking operation. Here, it is possible that the parking control device initiates a measurement of a parking space after a driver of the motor vehicle has signaled to the parking control device, e.g., using an input button, that a parking operation is to take place now. Alternatively, the parking control device initiates the measurement of any potential parking space if the speed of the vehicle falls below a limiting value, e.g., 50 km/h, in particular 20 km/h.

If the method according to the present invention is a part of a semi-autonomous or autonomous parking operation, the control unit may be a part of the parking control device which controls the semi-autonomous or autonomous parking operation. Likewise, it is possible that the control unit is only implemented by one or multiple software components of the parking control device. Within the scope of the disclosure content, the term “the control unit” may be replaced with the term “the parking control device” in this specific embodiment, in particular.

The driver may advantageously determine himself, in particular manually, into what type of parking space he wants to park. In particular, the driver may determine what type of parking space the parking space measured by the parking control device is. Here, the driver may, for example, determine the type of the parking space by using an input button, thus generating a signal which is forwarded to the control unit. This makes it possible that in step a. of the method according to the present invention, the control unit detects the type of parking space into which the motor vehicle is to be parked with the aid of a received signal, the signal being generated by the driver specifying the type of the parking space. In this case, the method according to the present invention may be carried out even if neither an autonomous nor a semi-autonomous parking operation is involved. Alternatively, it is conceivable that the parking control device establishes itself during the measurement of the potential parking space what type of parking space is involved in the case of the potential parking space and this information is made available to the control unit. This also results in step a. In another alternative, the parking control device may suggest the type of parking space to which the parking space control device would assign the potential parking space, the driver being able to correct or confirm the suggestion of the parking control device using an input button or, in the case of multiple suggestions, select one suggestion. The information regarding the confirmed, selected, or corrected type of parking space is available to the control unit, e.g., as a part of the parking control device, so that step a. results.

If the type of parking space into which the motor vehicle is to be parked is a parallel parking space, the setting of the right-hand side mirror, which is adapted to the parallel parking space, may be a setting in the case of which the driver probably sees a potentially present curb in the right-hand side mirror. For this purpose, the right-hand side mirror must usually be further adjusted toward ground. It corresponds to an advantageous setting of the left-hand side mirror, which is adapted to the parallel parking space, if the driver probably sees in the left-hand side mirror an outside edge of a potential object, which is located behind the parking space.

If the type of parking space into which the motor vehicle is to be parked is a perpendicular parking space, the setting of the right-hand side mirror, which is adapted to the perpendicular parking space, may be a setting in the case of which the driver probably sees in the right-hand side mirror a potentially present edge of an object, around which the parking motor vehicle must be moved during parking. This object is thus located in the inner radius of the path which the parking motor vehicle travels. It corresponds to an advantageous setting of the left-hand side mirror, which is adapted to the perpendicular parking space, if the driver probably sees in the left-hand side mirror an outside edge of an object, which is located behind the parking space. This object is thus located behind the outer radius of the path which the parking vehicle travels.

The objects described in the two previous sections may, in particular, be a parking motor vehicle, an obstacle, or the like. The objects which are described in the two previous sections and which the driver sees in the right-hand or left-hand side mirror during a parking operation into a parallel parking space or a perpendicular parking space do not have to be visible during the entire parking operation, but only during a relevant part of the parking operation. The part of the parking operation is considered relevant, in particular, during which the above-described objects are supposed to be visible in order to avoid collisions.

In one specific embodiment of the present invention, it is assumed that the above-described mirror settings which are advantageous for the left-hand side mirror when parking into a parallel parking space and/or for the left-hand and/or right-hand side mirror when parking into a perpendicular parking space correspond to the settings which are advantageous for the driver also during the drive itself with the motor vehicle and which the driver has therefore already set at the beginning of the drive. In this specific embodiment, only those side mirrors are therefore adjusted for which it cannot be assumed that the setting is advantageous during the drive or also during the parking operation. In particular, it is possible that the right-hand side mirror is adjusted in step b. only if the vehicle parks into a parallel parking space.

Alternatively, it is conceivable that both side mirrors are adjusted toward the ground during a parking operation into a parallel parking space.

In one advantageous specific embodiment of the present invention, the at least one setting, which is supposed to be adjusted for the side mirror during the parking operation into a parallel parking space and/or perpendicular parking space, is stored as a fixed value in the control unit or in the parking control device. Here, it is possible that this setting is predefined by the manufacturer. Alternatively, it is possible that the driver is able to predefine this setting which is then stored and reused. The control unit or the parking control device now uses this stored setting in step b. as a function of the type of parking space known from step a. Here, it is possible that only the setting of the right-hand side mirror to be adjusted for the parking operation into a parallel parking space is stored.

In one alternative specific embodiment of the present invention, the control unit computes prior to step b. the setting of the side mirror based on the coordinates of the edges of the objects, measured with the aid of the parking control device, and on the type of parking space. Here, the control unit may optionally have available data concerning the seating position of the driver which the control unit may use when computing the correct setting of the side mirror.

It is conceivable that the side mirror is adjusted only shortly before the moment at which the motor vehicle starts backing into the parking space. This moment may, for example, be considered by the control unit as present when the reverse gear is engaged so that an adjustment of the side mirror in step b. does not take place until after the driver has shifted into the reverse gear. It is thus conceivable that, if step a. has already taken place before the reverse gear is engaged, the control unit waits for the reverse gear to be engaged and subsequently initiates adjustment of the side mirror in step b. directly after the reverse gear has been engaged. If, however, the reverse gear is engaged prior to step a., steps a. and b. may follow each other directly.

It is possible that the control unit or the parking control device having the control unit are in a sleep mode or are switched off and are activated by another step prior to step a. In the step, the control unit or the parking control device detects via a received signal that the parking operation is to take place. The signal may be generated by the driver of the motor vehicle activating a parking control device for a parking space search, by the motor vehicle standing still, by falling below a predefined speed, or by the driver shifting into a reverse gear.

The side mirror may be automatically reset to a setting which is advantageous for the side mirror during a drive, at least after the parking operation has taken place. In this case, the method according to the present invention also ensures a setting of the side mirror which is advantageous for a drive following a parking operation. Here, it is possible that the side mirror is reset to the setting advantageous for the drive every time the forward gear is engaged during the parking operation and it is adjusted to the setting advantageous for the parking operation every time the reverse gear is engaged. Here, step a. advantageously takes place only once prior to the moment at which the motor vehicle starts to back into the parking space. Alternatively, the side mirror may be reset automatically only at the end of the entire parking operation. The end of the parking operation may, for example, be recognized by the parking control device when a desired end position of the motor vehicle is reached. The end of the parking operation may, however, also be detected by the control unit based on appropriate signals such as a prolonged standstill of the motor vehicle, a deactivation of the parking control device, or an adjustment of the ignition key. Alternatively, the side mirror may be automatically reset to a setting, which is advantageous for the side mirror during a drive, at the beginning of a new drive. The beginning of a new drive may, for example, be detected by the control unit based on the insertion of the ignition key. The setting, which is advantageous for the side mirror during a drive, may be the setting which is present at the beginning of the method according to the present invention and which is stored by the control unit. Alternatively, fixed values for the setting, which are predefined by the manufacturer or the driver and to which the side mirror is reset, may be stored in the control unit.

In one specific embodiment of the present invention, it is possible that the method may be deactivated by the driver. In this specific embodiment, the driver is able to decide whether or not the method is carried out during the parking operation.

The object of the present invention is also achieved by a control system for adjusting at least one side mirror of a motor vehicle. The control system has a control device for automatically adjusting the side mirror and a control unit, the control unit being in particular suitable to carryout the method according to the present invention.

The control device may be a separate assembly from the parking control device and/or the control unit. Alternatively, the control device, the control unit, and/or the parking control device may be implemented as one assembly, e.g., on a PC board or with an arithmetic unit. The control device, the control unit, and the parking control device are situated in a motor vehicle. The control device, the control unit, and/or the parking control device may be part of a control system which is used to control other functions of the motor vehicle.

Other measures enhancing the present invention are derived from the following description of the exemplary embodiments of the present invention which is schematically illustrated in the figures. All features and/or advantages derived from the claims, the description, or the drawings, including constructive details, spatial configuration, and method steps, may each be essential for the present invention either individually or in combination.

### BRIEF DESCRIPTION OF THE DRAWINGS

FIG. 1a shows an advantageous setting of the side mirror in a parallel parking space.

FIG. 1b shows an advantageous setting of the side mirror in a perpendicular parking space.

FIG. 2a shows a first exemplary embodiment for a method according to the present invention.

FIG. 2b shows a second exemplary embodiment for a method according to the present invention.

FIG. 2c shows a third exemplary embodiment for a method according to the present invention.

FIG. 3a shows a first exemplary embodiment for a control system according to the present invention.

FIG. 3b shows a second exemplary embodiment for a control system according to the present invention.

### DETAILED DESCRIPTION

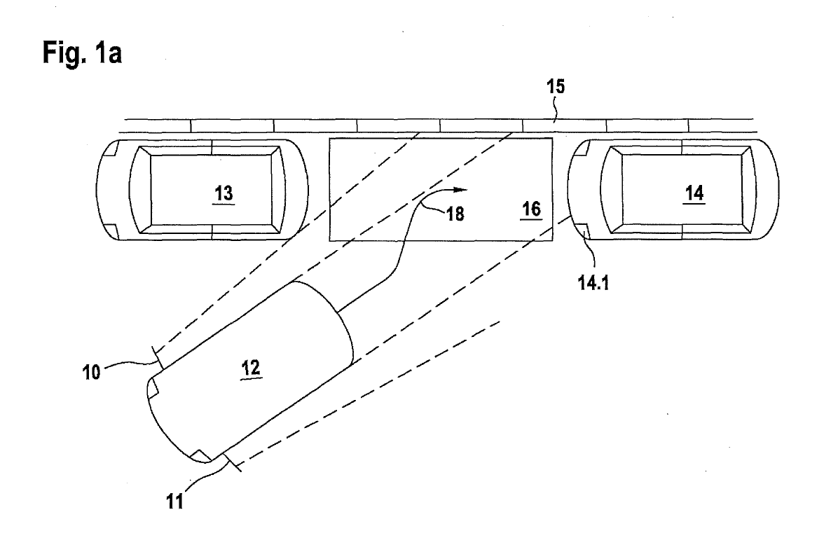

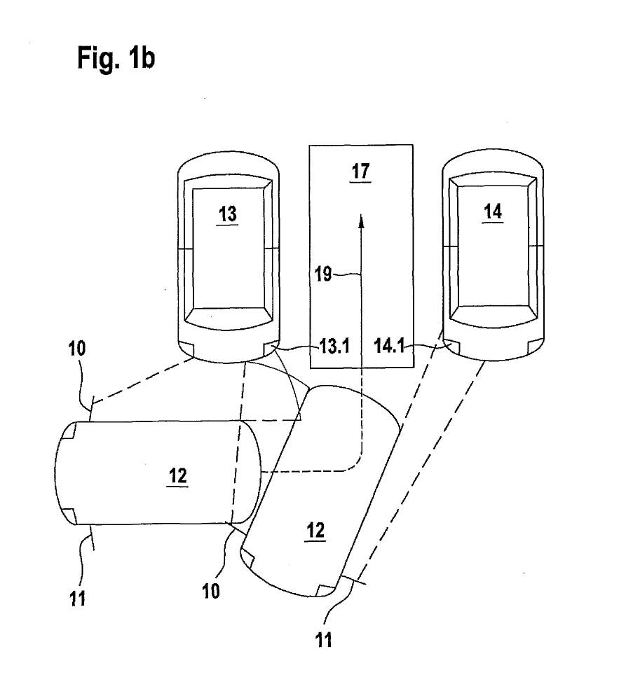

FIG. 1a shows a parallel parking space 16 between two already parked motor vehicles 13, 14 into which a driver of a motor vehicle 12 intends to park following a path 18. Side mirrors 10, 11 of motor vehicle 12 are set in such a way that, during a relevant part of parking operation EP, the driver is able to see a curb 15 in right-hand side mirror 10 and a front edge 14.1 of motor vehicle 14, which is adjacent to parallel parking space 16, in left-hand side mirror 11. For this purpose, right-hand side mirror 10 is adjusted downward.

FIG. 1b shows a perpendicular parking space 17 between two already parked motor vehicles 13, 14 into which a driver of a motor vehicle 12 intends to park following a path 19. Side mirrors 10, 11 of motor vehicle 12 are set in such a way that, during a relevant part of parking operation EP, the driver is able to see in right-hand side mirror 10 a front edge 13.1 of motor vehicle 13, which is adjacent to perpendicular parking space 17 and in left-hand side mirror 11 a front edge 14.1 of motor vehicle 14, which is adjacent to perpendicular parking space 17. The motor vehicle is illustrated in two different positions of path 19.

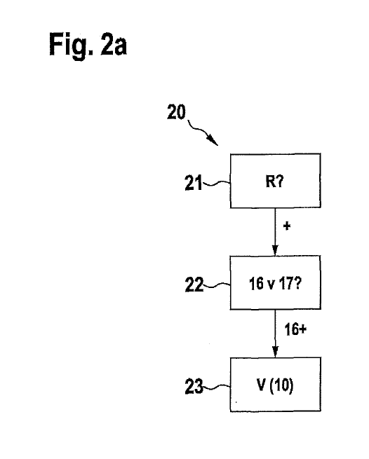

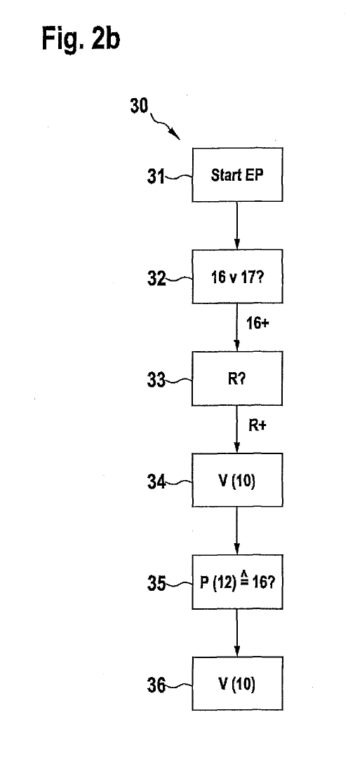

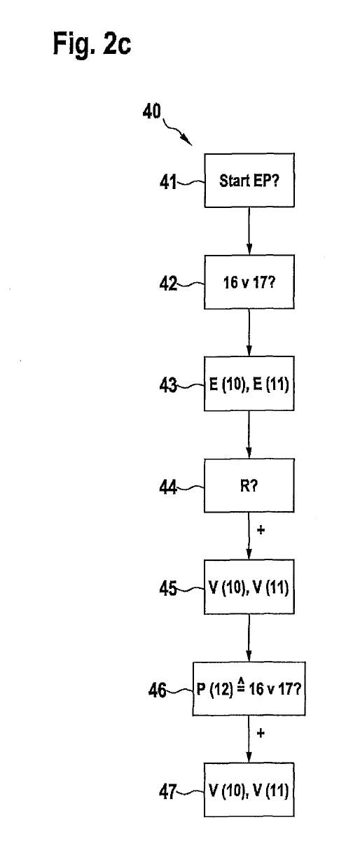

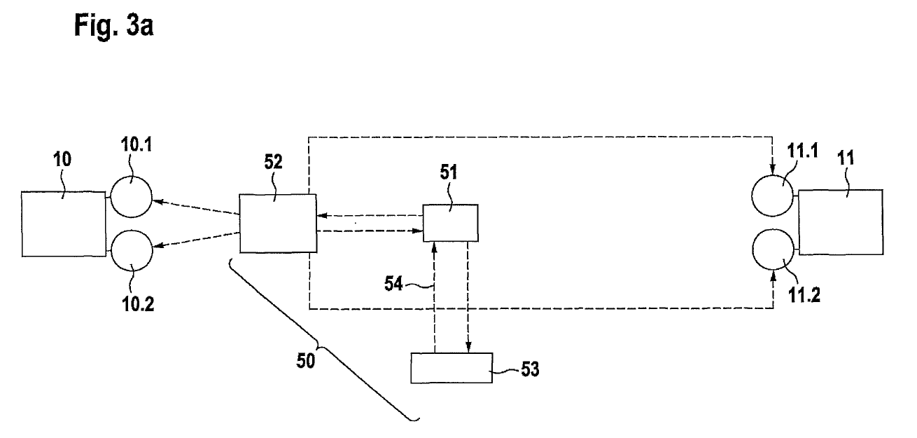

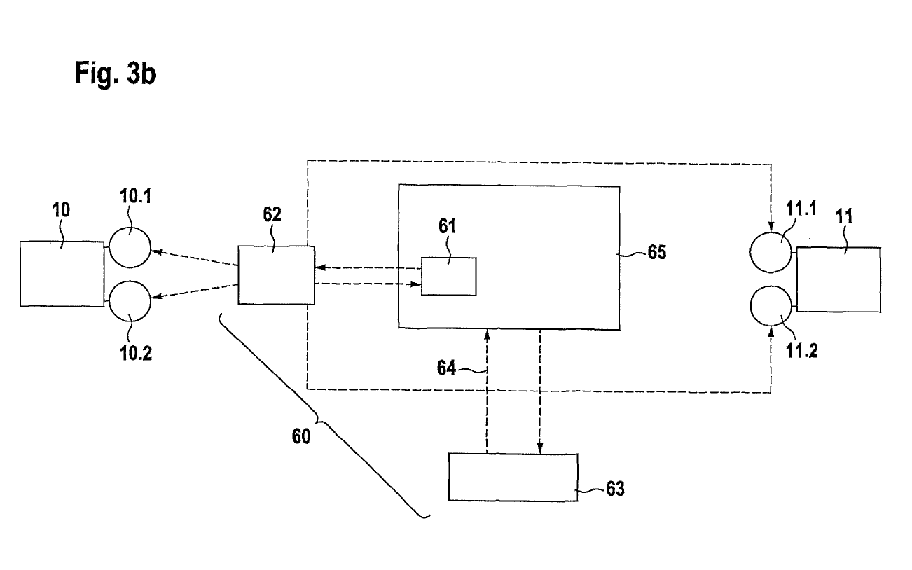

FIGS. 2a through 2c show three different exemplary embodiments of methods 20, 30, 40 according to the present invention. A control system 50, using which the method illustrated in FIG. 2a may be carried out, is illustrated in FIG. 3a. A control system 60, using which methods 30, 40 illustrated in FIGS. 2b and 2c may be carried out, is illustrated in FIG. 3b. Communication lines are illustrated as dashed lines in FIGS. 3a and 3b.

In FIG. 2a, a control unit 51 illustrated in FIG. 3a detects as a first step 21 of method 20 that a parking operation EP is to take place. Here, control unit 51 receives a signal via a communication line (not illustrated) that a reverse gear R has been engaged. In a second step 22, control unit 51 asks the driver, via a display 53 with the aid of input buttons (not illustrated), whether the driver intends to park into a parallel parking space 16 or a perpendicular parking space 17. If control unit 51 learns via a communication line 54 that the driver intends to park into a parallel parking space 16, control unit 51 sends in a further step 23 signals to a control device 52, which is able to adjust side mirrors 10, 11 via motors 10.1, 10.2, 11.1, 11.2, that right-hand side mirror 10 is to be adjusted in such a way that a potentially present curb 15 is visible in right-hand side mirror 10. Setting E (10) into which right-hand side mirror 10 is to be adjusted is stored in control unit 51 as a fixed value. Now, right-hand side mirror 10 is adjusted. If, however, control unit 51 learns in step 22 that the driver intends to park into a perpendicular parking space 17, control unit 51 does not send signals to control device 52 and step 23 does not take place.

In FIG. 2b, method 30 according to the present invention is integrated into a semi-autonomous parking operation EP, only method steps which are relevant for method 30 according to the present invention being illustrated. A control unit 61 illustrated in FIG. 3b is a part of a parking control device 65, it being assumed in the following that relevant information is available to control unit 61 in methods 30, 40 via parking control device 65. The term “control unit 61” may be replaced in the following by the term “parking control device 65.”

The driver starts semi-autonomous parking operation EP by communicating to parking control device 65, illustrated in FIG. 3b, in a step 31 via a display 63 with the aid of input buttons (not illustrated) that he intends to park. Subsequently, parking control device 65 starts measuring potential parking spaces. Parking control device 65 then inquires in a step 32 with the aid of display 63 whether the driver considers the measured parking space to be a parallel parking space 16 or a perpendicular parking space 17. A corresponding input by the driver is forwarded via a communication line 64 to parking control device 65. If the motor vehicle is parked into a perpendicular parking space 17, control unit 61 does not initiate further steps for adjusting side mirrors 10, 11. If, however, the motor vehicle is parked into a parallel parking space 16, control unit 61 waits for reverse gear R to be engaged, which is communicated to parking control device 65 via a signal in step 33. Subsequently, control unit 61 sends in a step 34 signals to a control device 62, which is able to adjust side mirrors 10, 11 via motors 10.1, 10.2, 11.1, 11.2, that right-hand side mirror 10 is to be adjusted in such a way that a potentially present curb 15 is visible in right-hand side mirror 10. Setting E(10) into which right-hand side mirror 10 is to be adjusted is stored in parking control device 65 as a fixed value. Control device 62 now adjusts right-hand side mirror 10. Now, the driver determines the speed of motor vehicle 12, while parking control device 65 controls the steering, and motor vehicle 12 stops after traveling path 18, 19 computed by parking control device 65 in step 32. If parking control device 65 recognizes in a step 35 that a position P(12) of motor vehicle 12 corresponds to parallel parking space 16, control unit 61 initiates in a step 36 the resetting of right-hand side mirror 10 by control device 62 to its previous position which was stored in parking control device 65.

In FIG. 2c, method 40 according to the present invention is part of an autonomous parking operation during which only the steps relevant to method 40 are illustrated. If the speed of motor vehicle 12 falls below a maximum speed of 50 km/h, for example, parking control device 65 continuously ascertains and measures potential parking spaces. If the driver inputs via display 63 in a step 41 that he intends to park, parking control device 65 suggests to the driver via display 63 into which parking space he could park and whether this parking space is a parallel parking space 16 or a perpendicular parking space 17. If the driver agrees via display 63 in a step 42 with the suggestion or corrects it, parking control to device 65, in particular control unit 61, computes based on this information and the coordinates of parking motor vehicles 13, 14 in a step 43 an optimal setting E(10), E(11) for right-hand and left-hand side mirrors 10, 11 as a function of the type of parking space. Here parking control device 65 may optionally be given data regarding a seating position of the driver. Now, control unit 61 waits for reverse gear R to be engaged, which is communicated to parking control device 65 via a signal in step 44. Subsequently, control unit 61 sends in a step 45 signals to a control device 62 that both side mirrors 10, 11 are to be adjusted according to computed setting E(10), E(11), whereupon side mirrors 10, 11 are adjusted. During parking operation EP, the steering and the speed are controlled by parking control device 65, and motor vehicle 12 stops after traveling path 18, 19 computed by parking control device 65 in step 42. If parking control device 65 recognizes in a step 46 that motor vehicle 12 is in a correct position in parking space 16, 17, control unit 61 initiates in a step 47 the resetting of side mirrors 10, 11 by control device 62 to their previous positions which are stored in parking control device 65.

The adjustment of the right-hand side mirror is referred to as V(10) in FIGS. 2b and 2c, and the adjustment of the left-hand side mirror is referred to as V(11) in FIG. 2c.

1-10. (canceled)

11. A method for providing a setting, which corresponds to a type of parking space, of at least one side mirror of a motor vehicle during a parking operation, the method comprising:
detecting, using a control unit of the motor vehicle, the type of parking space into which the motor vehicle is to be parked; and
initiating, using the control unit, an adjustment of the side mirror to a setting which is adapted to the type of parking space detected if an instantaneous setting of the side mirror does not correspond to the setting which is adapted to the type of parking space detected.

12. The method of claim 11, wherein the parking operation is part of an autonomous or semi-autonomous parking operation which is performed with the aid of a parking control device.

13. The method of claim 11, wherein in the detecting, the control unit recognizes the type of parking space into which the motor vehicle is to be parked based on a received signal, the signal being generated at least one of by a driver predefining the type of parking space into which the motor vehicle is to be parked, and by the parking control device ascertaining the type of parking space into which the motor vehicle is to be parked by measuring the surroundings of the motor vehicle.

14. The method of claim 11, wherein an adjustment (V(10), V(11)) of the side mirror (10, 11) in step b. does not take place until after the driver has shifted into the reverse gear (R), in particular, the side mirror (10, 11) is adjusted in step b. directly after the reverse gear (R) has been engaged, if step a. has already taken place prior to the engagement of the reverse gear (R).

15. The method of claim 11, wherein a setting of the right-hand side mirror, which is adapted to a parallel parking space, is configured so that the driver sees a potentially present curb in the side mirror, in which the side mirror is adjusted downward when the adjustment is initiated.

16. The method of claim 11, wherein a setting of the right-hand side mirror, which is adapted to a perpendicular parking space, is configured so that the driver sees in the side mirror a potentially present edge of an object, around which the motor vehicle must be moved during the parking operation.

17. The method of claim 11, wherein the side mirror is reset at least at the end of the parking operation.

18. A control system for adjusting at least one side mirror of a motor vehicle, comprising:
a control device to automatically adjust the side mirror;
a control unit to detect a type of parking space into which the motor vehicle is to be parked, and to initiate an adjustment of the side mirror to a setting of the side mirror which is adapted to the type of parking space into which the motor vehicle is to be parked, wherein if an instantaneous setting of the side mirror does not correspond to the setting which is adapted to the type of parking space into which the motor vehicle is to be parked.

19. The control system of claim 18, wherein the control unit is a part of a parking control device for one of autonomous parking and semi-autonomous parking.

20. The control system of claim 18, wherein control unit is operable for performing the following:
detecting the type of parking space into which the motor vehicle is to be parked; and
initiating the adjustment of the side mirror to the setting which is adapted to the type of parking space detected if the instantaneous setting of the side mirror does not correspond to the setting which is adapted to the type of parking space detected.
